(19) United States
(12) Patent Application Publication
(10) Pub. No.: US 2016/0090181 A1
(43) Pub. Date: Mar. 31, 2016

(54) AIRCRAFT SOFA CONVERTIBLE TO BED

(71) Applicant: Hamilton Sundstrand Corporation, Windsor Locks, CT (US)

(72) Inventor: Kurt F. Breuer, Marinette, WI (US)

(21) Appl. No.: 14/499,973

(22) Filed: Sep. 29, 2014

(51) Int. Cl. B64D 11/06

(52) U.S. Cl. CPC B64D 11/0641; B64D 11/0642

(57) ABSTRACT

An aircraft sofa convertible to a bed is provided. The sofa-bed includes at least one seat including a seating surface and back support. A drawer is disposed underneath the seating surface and configured to extend outward from underneath the seating surface to define an under-seat compartment. The drawer also includes a panel system that is configured to be deployed in stages within the drawer for deployment of the sofa-bed to the bed and support at least one cushion. A lever-control handle is adapted to latch/lock in place panels of the panel system and release the panels therefrom. A bearing pad automatically drops into position by the deployment of the panel system and reacts to a downward load on a floor of a cabin of the aircraft located under the sofa-bed.

### BACKGROUND OF INVENTION

This invention relates, generally, to sofa (divan) for a vehicle and, more specifically, to a sofa that is convertible to a bed (berth) for an aircraft.

The known aircraft convertible sofa (divan) typically incorporates sliding and/or hinged bed panels that are stowed atop of a seating surface of the sofa and configured to be extended. After the bed panels have been extended to form a bed (berth), a downward load under the bed is transmitted through supports that are manually and individually folded down and impart a concentrated load upon a carpeted floor of a cabin of an aircraft. The sofa-bed also includes multiple structural elements for attachment to the floor.

It is desirable to provide an aircraft sofa that converts into a bed and is suitable for take-off and landing in a “sofa” configuration and in-flight use in a “bed” configuration. It is desirable also that the sofa-bed does not compromise height or comfort of seating of the sofa-bed, impart an undesirable concentrated load upon the floor of the aircraft, or reduce capability of the sofa-bed to stow mechanisms of the bed or other items underneath the seating surface of the sofa-bed. It is desirable also that the sofa-bed be structurally capable of sustaining a significant amount of static and dynamic loads.

### BRIEF DESCRIPTION OF INVENTION

According to a non-limiting exemplary embodiment of the invention, an aircraft sofa convertible to a bed is provided. The sofa-bed includes at least one seat including a seating surface and back support. A drawer is disposed underneath the seating surface and configured to extend outward from underneath the seating surface to define an under-seat compartment. The drawer also includes a panel system that is configured to be deployed in stages within the drawer for deployment of the sofa-bed to the bed and support at least one cushion. A lever-control handle is adapted to latch/lock in place panels of the panel system and release the panels therefrom. A bearing pad automatically drops into position by the deployment of the panel system and reacts to a downward load on a floor of a cabin of the aircraft located under the sofa-bed.

The aircraft sofa converts into a bed and is suitable for take-off and landing in a “sofa” configuration and in-flight use in a “bed” configuration. The sofa-bed also does not compromise height or comfort of seating of the sofa-bed, impart an undesirable concentrated load upon the floor of the aircraft, or reduce capability of the sofa-bed to stow mechanisms of the bed or other items underneath the seating surface of the sofa-bed. The sofa-bed also is structurally capable of sustaining a significant amount of static load.

### BRIEF DESCRIPTION OF DRAWING

The subject matter that is regarded as the invention is particularly pointed out and distinctly claimed in the claims at the conclusion of the specification. The foregoing and other features and advantages of the invention are apparent from the following detailed description taken in conjunction with the accompanying drawing in which:

FIG. 1 is a side view of a non-limiting exemplary embodiment of an aircraft sofa (divan) convertible to a bed (berth) according to the invention showing the sofa-bed fully stowed for take-off and landing of the aircraft.

FIG. 2 is a side view of the aircraft convertible sofa illustrated in FIG. 1 showing a first stage of deployment of the sofa-bed to the bed.

FIG. 3 is a side view of the aircraft convertible sofa illustrated in FIG. 1 showing a second stage of the deployment.

FIG. 4 is a side view of the aircraft convertible sofa illustrated in FIG. 1 showing a third stage of the deployment.

FIG. 5 is a side view of the aircraft convertible sofa illustrated in FIG. 1 showing a fourth stage of the deployment.

FIG. 6 is a side view of the aircraft convertible sofa illustrated in FIG. 1 showing the sofa-bed fully deployed to the bed for use thereof during flight of the aircraft.

### DETAILED DESCRIPTION OF INVENTION

Referring now to the figures, a non-limiting exemplary embodiment of a sofa (divan) convertible to a bed (berth) of a fuselage or cabin of an aircraft (not shown) is generally indicated at 10. Although the sofa-bed 10 is disclosed herein as being implemented with an aircraft, it should be appreciated that the sofa-bed 10 can be implemented with other suitable vehicles, such as boats and other recreational vehicles. It should be appreciated also that the sofa-bed 10 can be used as a household convertible sofa (but, in such use, does not need structural capability to be crash-tested). And, although the sofa-bed 10 is designed as being aft-facing with respect to the aircraft, it should be appreciated that the sofa-bed 10 can face in any suitable direction respect to the aircraft.

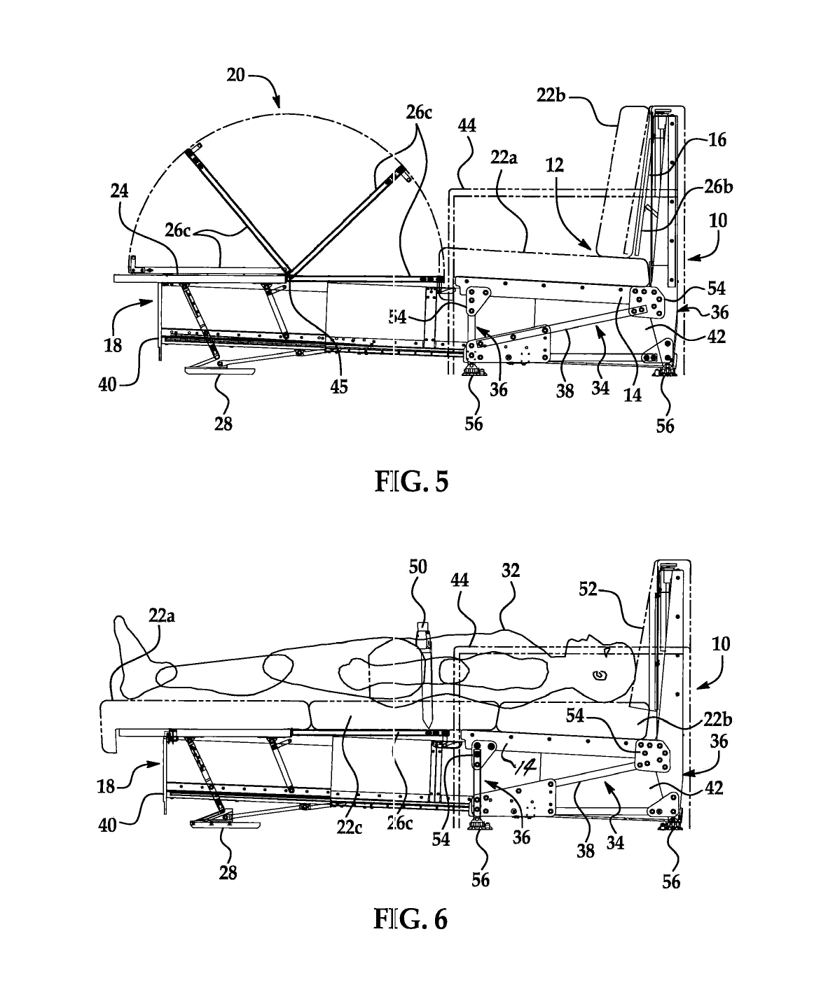

As shown in the figures, the sofa-bed 10 includes, in general, at least one aft-facing seat, generally indicated at 12, including a seating surface 14 and seat back or back support 16. A drawer, generally indicated at 18, is disposed underneath the seating surface 14 and configured to extend outward from underneath the seating surface 14 to define. The drawer 18 also includes a panel system, generally indicated 20 in FIG. 5, that is configured to be deployed in stages within the drawer 18 for deployment of the sofa-bed 10 to the bed and support at least one mattress or cushion 22. A lever-control handle 24 (FIGS. 4 and 5) is adapted to latch/lock in place panels 26 of the panel system 20 and release the panels 26 therefrom. A bearing pad 28 automatically deploys or drops into position by the deployment of the panel system 20 and reacts to a downward load on a floor 30 (FIG. 4) of a cabin of the aircraft located under the sofa-bed 10.

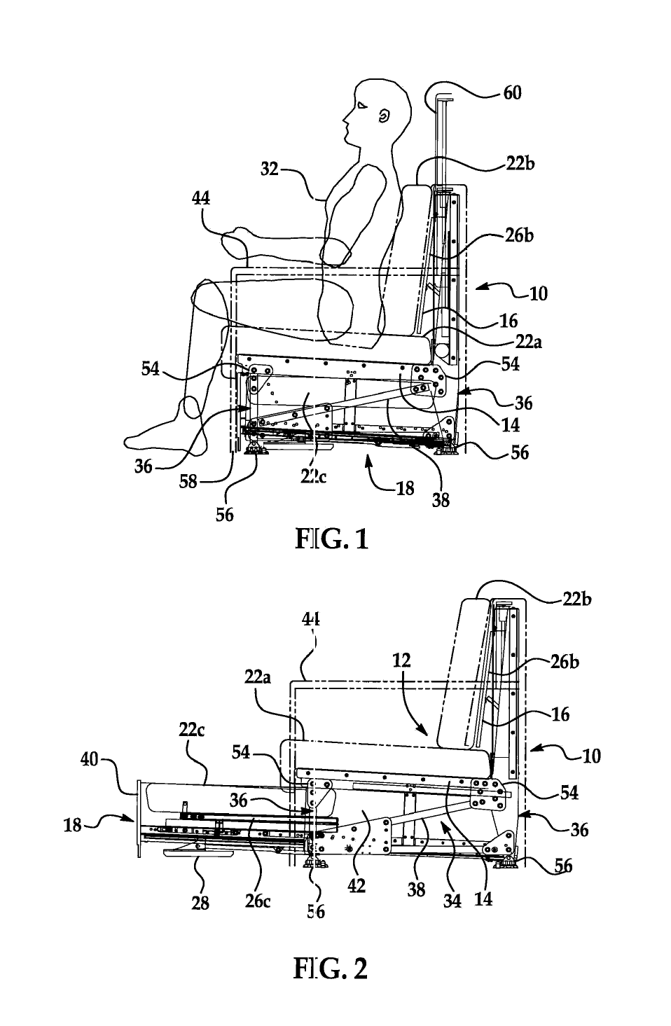

With respect to the sofa-bed 10 being implemented for seating and in an aspect of the embodiment, FIG. 1 shows the sofa-bed 10 fully stowed for take-off and landing of the aircraft. The sofa-bed 10 is a combination or set of the seats 12 forming a bench or similar grouping of individual seats 12—i.e., the seating surface 14 and back support 16 define an individual seat or a bench upon which an individual, an occupant, or a passenger 32 (FIGS. 1 and 6) or set of passengers 32 can sit. (In the figures, the bench or similar grouping of individual seats 12 is shown incomplete, and only one passenger 32 is shown).

The sofa-bed 10 includes also at least one support structure, generally indicated at 34, and a set of legs, generally indicated at 36, used as seat-to-aircraft attachments. The seat 12 and support structure 34 can be formed of materials similar to those of the legs 36—namely, steel, titanium, alloys thereof, or similar lightweight and high-strength materials. The seat 12 can have any size or dimensions (e.g., depth and thickness) appropriate for an aircraft and be formed from multiple supports or long continuous supports. Similarly, any number of seats 12 can be coupled together, including combinations of two, three, four, five, and six seats 12. The sofa-bed 10 can also define discrete seats 12 or a general bench that is designed to seat a discrete number of the passengers 32. Sets of the legs 36 can be shared between corresponding adjacent individual seats 12 or spaced along the bench to support a weight of the number of passengers 32 for which the bench was designed. This reduces a number of the legs 36 and parts needed to assemble the sofa-bed 10 in comparison to a number needed for the individual seats 12 to accommodate the same number of passengers 32.

The support structure 34 includes any number of cross members, supports, or similar structures 38 that distribute weight of the seating surface 14, back support 16, and passenger 32 over the set of legs 36 and link each of the legs 36 or connect the legs 36 to the seat 12. The seating surface 14 and back support 16 can have any width, height, or length, depending upon occupancy and similar requirements for the seat 12. Similarly, the back support 16 can also be positioned to be any distance from a front edge of the seat 12. A cross member 38 also is directly coupled to a back leg 36 and front leg 36. The seating surface 14 and back support 16 can also include additional mechanisms and functionality—including positional adjustment, reclining, collapsibility, and similar features incorporation of which should be readily appreciated such that discussion thereof has been omitted for sake of clarity.

The drawer 18 defines front and side shrouds 40 (only the front one being shown) that shroud the panels 26. The shrouds 40 can be decorative to present a more acceptable appearance of the sofa-bed 10. Extension of the drawer 18 outward from underneath the seating surface 14 defines an under-seat compartment 42. The under-seat compartment 42 can be enclosed by the shrouds 40 and provide a stowage space for storage of life vests, life rafts, and similar emergency equipment. The legs 36 protect the under-seat compartment 42 from being compressed by dissipating axial and sheering forces and similar energy and, thereby, prevent damage to contents of the under seat-compartment 42.

The seating surface 14 and back support 16 are each covered with a cushion 22 in the form of upholstered foam or similar padding or similarly adorned to improve comfort of the passenger 32. More specifically, the seating surface 14 is covered with cushion 22a, and the back support 16 is covered with cushion 22b. Furthermore, cushion 22c is deployably stowed in the drawer 18.

The panels 26 of the panel system 20 include panel 26b disposed directly and immediately behind cushion 22b and panel 26c disposed directly and immediately beneath cushion 26c. Panel 26b is configured to support cushion 22b and be folded downward to be stored vertically. In the embodiment, panel 26b serves as the back support 16. Panel 26c is configured to support cushion 22c when stowed.

An upholstered arm rest 44 is attached to each end of the sofa-bed 10, includes a leather seam and cap, and defines clearance. More specifically, the arm rest 44 provides a space for placement of multi-media controls (such as audio and video controls, attendant-service buttons, temperature controls, and environmental controls), cup holders, collapsible tables, and similar conveniences or features. For instance, an adjustable leather-covered tray can be stowed in the arm rest 44. Any number and combination of these features can be included in the arm rest 44. Arm rests 44 and similar components can be situated in the middle of or within the sofa-bed 10 to define respective individual seats 12. Any number of arm rests 44 can be included in the sofa-bed 10 to define the individual seats 12.

The sofa-bed 10 may be set up as a row perpendicular to an outer wall of the cabin or situated against the outer wall, in which case the sofa-bed 10 can be mounted to the wall and floor 30. The sofa-bed 10 can also be positioned against and mounted to interior walls of the cabin or upon a seat track (not shown) of the floor 30. The drawer 18 is configured to slide along integral linear bearings.

With respect to the sofa-bed 10 being implemented for bedding and in an aspect of the embodiment, FIGS. 2-5 show respective stages of deployment of the sofa-bed 10 to the bed, in general (and certain structure thereof, in particular), and FIG. 6 shows the sofa-bed 10 fully deployed to the bed for in-flight use thereof

Referring now to FIG. 2, a first stage of deployment of the sofa-bed 10 to a bed is shown in which the drawer 18, including cushion 22c, is extended partially outward horizontally from underneath the seating surface 14. In this way, only a portion of cushion 22c is disposed below cushion 22a, and the stowage space of the under-seat compartment 42 underneath the seating surface 14 is partially created.

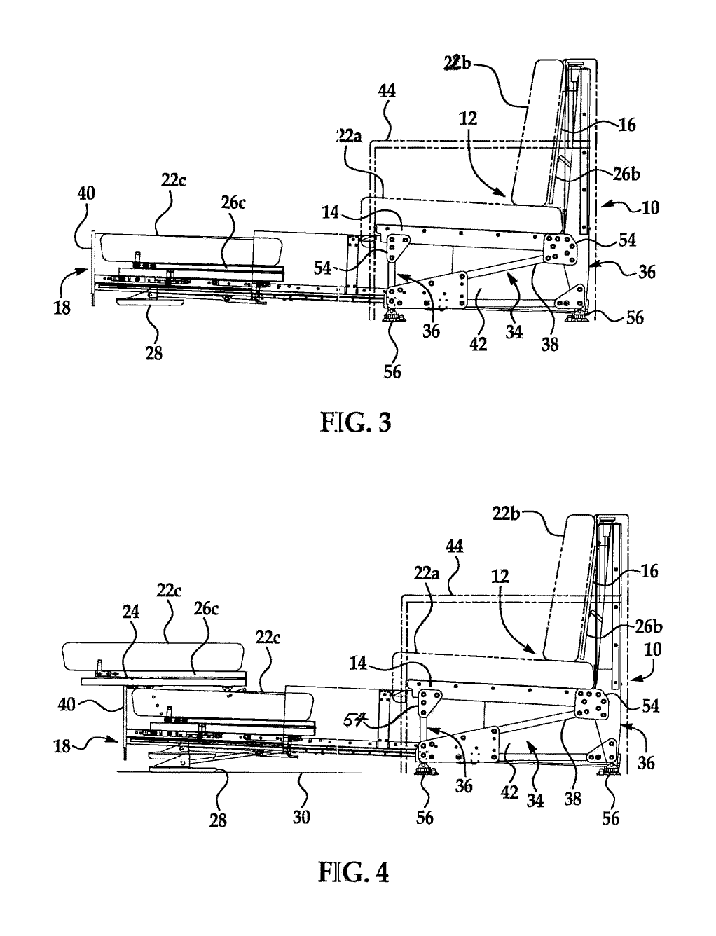

Referring now to FIG. 3, a second stage of the deployment is shown in which the drawer 18, including cushion 22c, is so extended completely outward. In this way, an entirety of cushion 22c is spaced from and disposed below cushion 22a, and the stowage space is completely created.

Referring now to FIG. 4, a third stage of the deployment is shown in which panel 26c is deployed. In this way, an entirety of cushion 22c is brought into alignment with (although still spaced from) cushion 22a. The bearing pad 28 automatically deploys or drops into position by the deployment of panel 26c and reacts to a downward load on the floor 30. In particular, the bearing pad 28 mechanically moves by the deployment of panel 26c (and the panel system 20, in general). Latch controls—i.e., the lever-control handle 24—latches/locks panel 26c in place after panel 26c is hooked in place. Panel 26c is hinged to the drawer 18 and configured to flip about a hinge 45 (FIG. 5).

Referring now to FIG. 5, a fourth stage of the deployment is shown in which panel 26c is deployed again. In this way, an entirety of panel 26c (without cushion 22c) is flipped about the hinge and folded over (toward cushion 22a) and down (adjacent to and in alignment with the seating surface 14) and then hooked in place.

Referring now to FIG. 6, the sofa-bed 10 is shown fully deployed to the bed for use thereof during flight of the aircraft. The sofa-bed 10 defines a tip-out surface 46 that is configured to be moved (in particular, folded) away from a vertical, stowed orientation such that the tip-out surface 46 is suitable for use as a back when the sofa-bed 10 is to be used for seating and move to the vertical orientation such that the tip-out surface 46 is suitable for use as a headboard when the sofa-bed 10 is to be used for bedding. Toward this end, the sofa comprises also a control 48 that is positioned in back and rotatable to move the tip-out surface 46 to the vertical orientation (i.e., a “headboard” configuration) and non-vertical orientation (i.e., “seating” configuration). A passenger-restraint system—in a form of a berthing belt 50—and fairing 52 configured to shield a view of an edge of the tip-out surface 46 are shown only in FIG. 6.

Each of the legs 36 includes a seat-mounting mechanism 54 and base frame or floor-mounting mechanism 56. The leg 36 also can be attached to different portions of a frame of the seat 12, such as interior ones, or at edges or ends of the seat frame. The leg 36 can also have any size or dimensions and be a hollow structure and roughly rectangular, cylindrical, or similarly shaped.

The seat-mounting mechanism 54 can be bolted, welded, or similarly fit or attached to the leg 36. The seat-mounting mechanism 54 can also define a set of holes through which attachments are utilized in conjunction with corresponding holes or structures of the seat frame and any number of attachment points. The seat-mounting mechanism 54 can be also secured to the seat frame by any number of attachments and welded onto the seat frame or similarly attached to the seat 12. The leg 36 also can be directly mounted onto the seat frame using any number of bolts, rivets, inter-locking parts, or similar attachments or structures or by form-fitting, welding, or similar techniques.

The floor-mounting mechanism 56 couples the leg 36 to the floor 30 and is designed to be bolted, welded, riveted, screwed, or similarly attached to the floor 30. Each component of the floor-mounting mechanism 56 can be formed from aluminum, titanium, steel, alloys thereof, or similar lightweight and high-strength materials (i.e., with high material and tensile strength). The floor-mounting mechanism 56 also defines holes for bolts, screws, or similar attachments or structures or attachment points for welding, riveting, or similar attaching. The floor-mounting mechanism 56 also is configured to dissipate sheering forces or distribute them between the seat 12 and floor 30 and allow for easy detachment of the seat 12 from the floor 30.

In an aspect of the embodiment, components of the sofa-bed 10, especially the legs 36, can be formed from steel, titanium, alloys thereof, or similar lightweight materials having a high material strength and capable of withstanding sheering and axial forces generated during a 16-G pulse or impact, which are often utilized as a benchmark in testing of aircraft components. The legs 36 can be also designed to dissipate forces acting upon the sofa-bed 10, thereby reducing the sheering and axial forces on the legs 36 and floor 30 and increasing a likelihood that the sofa-bed 10 is not dislodged and the floor 30 is not deformed or damaged. Avoidance of this dislodgement, deformation, and damage improves safety of the occupants during and after periods when extreme forces are acting or exerted on the seat 12, floor, 30, and legs 36 from testing, crashing, or similar events.

The sofa-bed 10 includes also a kick strip 58 (FIG. 1), at least one headrest 60 (FIG. 1) that is plugged into the sofa-bed 10 and may be stowed or adjusted by sliding down the headrest 60 behind the back support 16 and inside a rear portion of the sofa-bed 10, and a bed-deployment release (bed control). A touch-latch is configured to release the headrest 60 from a “stowed” configuration of the headrest 60. The sofa-bed 10 can include also non-metallic materials (including finishes or decorative surfaces)

The sofa 10 converts into a bed and is suitable for take-off and landing in a “sofa” configuration and in-flight use in a “bed” configuration. The sofa-bed 10 also does not compromise height or comfort of seating of the sofa-bed 10, impart an undesirable concentrated load upon the floor 30, or reduce capability of the sofa-bed 10 to stow mechanisms of the sofa-bed 10 or other items underneath the seating surface 14. The sofa-bed 10 also is structurally capable of sustaining a significant amount of static load.

More specifically, the sofa-bed 10 defines self-contained stowage for a cushion 22c and mechanisms pertaining to deployment of the sofa-bed 10 to the bed. Also, in the “sofa” configuration with two passengers, structure and internal mechanisms of the sofa-bed 10 are sufficiently robust to be dynamically crash-tested at 16 G and sufficiently flexible to sustain a required deformation of the seat track that is imposed upon the sofa-bed 10 prior to a crash test. And, in the “bed” configuration, the sofa-bed 10 can withstand vertical G with associated loads imposed by the two passengers and inertia loads originating from a mass of the sofa-bed 10 itself Furthermore, upward loads from the passengers are transmitted into structure of the sofa-bed 10 through restraint attachments with a path of the load following through the structure to the floor-mounting mechanism 56 and other structure attached to the floor 30. In addition, the attached structure and floor 30 disposed underneath a cantilevered portion of the sofa-bed 10 react to downward loads in the “bed” configuration with minimum pressure on the floor 30. Moreover, the sofa-bed 10 is configured to be slidingly deployed solidly and smoothly and released and locked by the single lever-control handle 24.

Also, the sofa-bed 10 defines the front and side shrouds 40 fully around the sofa-bed 10 to present a satisfactory appearance of the sofa-bed 10. And, an entirety of the sofa-bed 10 and additional segments are stowed internally. Furthermore, the bearing pad 28 can be automatically deployed to distribute downward loads under the sofa-bed 10 over a large area of the floor 30. In addition, the sofa-bed 10 is designed for 16-G dynamic crash-testing with only the legs 36 attached to the aircraft. Moreover, these attached structures are disposed only on respective ends of the sofa-bed 10, allowing a sufficient amount of clearance for mechanisms of the sofa-bed 10 to be fully stowed underneath the seating surface 14 of the sofa-bed 10.

While the invention has been described in detail in connection with only a limited number of embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. Additionally, while various non-limiting embodiments of the invention have been described, it is to be understood that aspects of the invention may include only some of the described embodiments. Accordingly, the invention is not to be seen as limited by the foregoing description, but is only limited by the scope of the appended claims.

1. A sofa of an aircraft convertible to a bed, the sofa-bed comprising:
at least one seat including a seating surface and back support;
a drawer that is disposed underneath the seating surface, configured to extend outward from underneath the seating surface to define an under-seat compartment and be positioned spaced from the seating surface, and includes a panel system that is configured to be deployed in stages within the drawer for deployment of the sofa-bed to the bed, support at least one cushion, and has at least one panel configured to be brought into spaced relationship with the seating surface and then flipped and folded to be positioned adjacent to and in substantial alignment with the seating surface; and
a bearing pad that automatically drops into position upon a floor of a cabin of the aircraft located under the sofa-bed by the deployment of the panel,
wherein the seating surface is located at an end of the drawer when the drawer is extended.

2-3. (canceled)

4. The convertible aircraft sofa of claim 1, wherein the drawer defines front and side shrouds that shroud the panels.

5-6. (canceled)

7. The convertible aircraft sofa of claim 1, wherein the bearing pad mechanically moves by the deployment of the panel system.

8. The convertible aircraft sofa of claim 1, wherein the sofa-bed comprises further at least one headrest that is plugged into the sofa-bed and adjustably stowable by sliding down the headrest behind the back support and inside a rear portion of the sofa-bed.

9. (canceled)

10. The convertible aircraft sofa of claim 1, wherein the drawer is configured to slide along integral linear bearings.

11-12. (canceled)

13. The convertible aircraft sofa of claim 1, wherein the sofa-bed comprises further a set of legs used as seat-to-aircraft attachments.

14. The convertible aircraft sofa of claim 13, wherein each of the legs includes a seat-mounting mechanism and floor-mounting mechanism.

15. The convertible aircraft sofa of claim 13, wherein the sofa-bed comprises further at least one support structure that is configured to distribute weight of the seating surface, back support, and at least one passenger of the aircraft over the set of legs and either of link each of the legs and connect the legs to the seat.
